(19) United States
(12) Patent Application Publication
(10) Pub. No.: US 2003/0091895 A1
(43) Pub. Date: May 15, 2003

(54) Water-activated primary battery particularly suitable for environmentally safe underwater use

(76) Inventor: Fernando Zocchi, Roma (IT)

Correspondence Address: FOGG SLIFER & POLGLAZE, P.A., P.O. BOX 581009, MINNEAPOLIS, MN, 55458-1009, US

(21) Appl. No.: 09/894,459

(22) Filed: Jun. 28, 2001

(30) Foreign Application Priority Data
Dec. 29, 1998 (IT) RM98A000811
Dec. 29, 1999 (IT) PCT/IT99/00427

(51) Int. Cl. H01M 6/32; H01M 4/46; H01M 6/04; H01M 2/14; H01M 2/02; H01M 2/12

(52) U.S. Cl. 429/118; 429/231.6; 429/347; 429/165; 429/129; 429/82

(57) ABSTRACT

A water-activated primary battery using magnesium or alloys thereof as the anode and a cathode of various material having a redox potential allowing a charge transfer reaction is described, said battery comprising one or more electrochemical cells enclosed in a casing (1), characterized in that it contains a pH buffer system formed by at least one acid having a ionization constant Kₐ≦0.1 moles/liter, in order to maintain in the electrolytic solution the concentration of the hydroxyl ions yielded by the reaction

Mg+2 H₂O→Mg²⁺+2 OH⁻+H₂↑

below the threshold value that causes the Mg(OH)₂ precipitation, said precipitation being also provoked by the increase of the Mg²⁺ concentration due to the anodic reaction

Mg→Mg²⁺+2 e

thereby avoiding the deposition of Mg (OH)₂ on the cathode with the consequent decrease of the voltage output from said battery.

### DESCRIPTION

The present invention relates to a water-activated primary battery particularly suitable for underwater use.

Water- (usually saltwater-) activated batteries, are particular reserve batteries that include an anode made of magnesium or of alloys thereof. Cathodes used in the state of the art include the AgCl/Ag, CuCl/Cu, PbCl₂/Pb, CuSCN/Cu, HCOOCu/Cu, Cu₂C₂O₄/Cu, CuC₂O₄/Cu, CuI/Cu, CuC₄H₄O₆Cu, CuO/Cu, PbO₂/Pb, HgO/Hg, MnO₂/MnOOH, H₂O/H₂ (steel), H₂O/H₂ (activated iron), H₂O/H₂ (platinum), H₂O/H₂ (rhodium) redox systems.

Both electrodes are stored in a dry condition and the water only enters between the electrodes just before the time of use.

Those types of battery have various drawbacks limiting the use thereof, most drawbacks being related to the self-discharge phenomena that take place as soon as these batteries are activated in water. The first problem, and perhaps the main one, is the formation of a white-coloured and powdery Mg(OH)₂ precipitate, that tends to fill up the space between electrodes and to deposit on the cathode with the consequent reduction in the transportation of the electrical charges. Hence, the CCV (closed circuit voltage) value of each individual cell and the delivered current tend to decrease more or less markedly, thus reducing the volumetric and the gravimetric capacities of the cell. Forced flow devices were adopted in an attempt to overcome this drawback, yet the use of such devices has been curbed by their complexity and their cost.

Furthermore, every water-activated battery has an unavoidable self-discharge factor: the magnesium reacts with the water of any aqueous solution with which it comes to contact, according to the following reaction:

Mg+2 H₂O→Mg²⁺+2 OH⁻+H₂↑ (I)

The above reaction being thermodynamically and kinetically favoured, cannot be avoided in any battery having an aqueous electrolyte and anodes made of magnesium.

In a battery with a magnesium anode either when it delivers current, or when it is still at open circuit, due to reaction (1) the pH of the electrolyte, and therefore the OH⁻ ion concentration, tend to increase. In the case of batteries with H₂O/H₂ system cathodes, the pH also increases due to the cathodic processes, as exemplified in the following reactions:

2 H₂O+2 e→H₂+2 OH⁻ (II)

2 H⁺+2 e→H₂ (III)

i.e., disappearance of H⁺ ions and shifting of the balance

H₂O [symbol] H⁺+OH⁻ (IV)

towards an increase of the OH⁻ ion concentration.

In addition to the pH increase, the Mg²⁺ ion concentration increases as well, due to reaction (1) and to the anodic process

Mg→Mg²⁺+2 e (V)

A continues increase in the Mg²⁺ and OH⁻ concentrations causes a swift reaching and overstepping of the solubility product value of the magnesium hydroxide, with the precipitation of the latter and the deposition thereof on the cathode, and the above-reported consequences.

In order to overcome those problems the present invention introduces the use, in the liquid acting as electrolyte, of a buffer system made of at least one weak acid with a specific value of the ionization constant.

A substance of acidic nature can exhibit buffer capacity with respect to a pH increase, both alone and in presence of a salt thereof. This is apparent from the titration curve of a weak acid with a strong base (e.g., NaOH). The exemplifying diagram in FIG. 1 relates to the titration of 1 liter of 0.1M acetic acid solution (HA) with a ionization constant of 1.85·10⁻⁵ moles/liter, having assumed that the addition of n moles of NaOH to the solution does not alter the volume of the latter.

The initial (i.e., prior to the NaOH addition) H⁺ ion concentration value can be derived from the expression of the ionization constant. Indicating with cₐ the analytical concentration of HA:

$${K}_{a} = \frac{[ {H}^{+} ] [ A ]}{[ HA ]} = \frac{[ {H}^{+} ] [ {A}^{-} ]}{{C}_{a}^{-} [ {H}^{+} ]} ≅ \frac{[ {H}^{+} ] [ A ]}{{C}_{a}} = \frac{{( [ {H}^{+} ] )}^{2}}{0.1} \qquad ( VI )$$

[H⁺]=(Kₐ[HA])^{½}=(1.85·10⁻⁵·0.1)^{½}=1.36·10⁻³ moles/liter; pH=2.87.

I.e., prior to the NaOH addition, the pH of the 0.1M HA solution is 2.87. Adding 0.01 moles of NaOH, the pH rises slightly (from 2.87 to 3.78), much less however than what would take place for a NaOH addition in pure water. The dotted line in FIG. 1 indicates the considerable pH increase (from 7 to 12) that would take place in the latter case. Thus, in the case of the weak acid HA a buffering of the pH was obtained. Such buffer capacity (dn/dpH), i.e. the reciprocal of the function derivative shown in the diagram, has its maximum at the point of inflection of the curve. In fact, the derivative of the function (dpH/dn), i.e. the slope of the tangent to the curve has a minimum value at the point of inflection. During the titration process of the weak acid HA, such point of inflection is reached when 50% of the moles of the acid (n=0.05) have been neutralized with the formation of a corresponding quantity moles of salt. Adding further NaOH the buffer capacity decreases, until it becomes practically nil when the NaOH moles exceed the initial acid moles (n>0.1).

It can be experimentally observed that for

pH≦2 i.e. [H⁺]≧1·10⁻² M (VII)

The magnesium reaction with the H⁺ ions becomes too violent, and therefore unacceptable in the batteries according to the present invention. Such acceptable threshold pH value is obtained, e.g., in 1M solutions of weak acids with a ionization constant of Kₐ=10⁻⁴ moles/liter. In fact,

$${K}_{a} = \frac{[ {H}^{+} ] [ {A}^{-} ]}{[ HA ]} ≅ \frac{{[ {H}^{+} ]}^{2}}{{C}_{a}^{-} [ {H}^{+} ]} = \frac{{[ {H}^{+} ]}^{2}}{{C}_{a}} = {10}^{- 4} moles / liter ;$$

[H⁺]=1·10⁻² M; pH=2

Making reference to the diagram in FIG. 1, it can be stated that solutions with [A⁻]>[HA] also exhibit a buffer action against pH increases, although of a lower degree than those exerted by a solution wherein [HA]=[A⁻]. However, it can be stated that if

[A⁻]≧10 [HA] (VIII)

the buffer action is comparatively small, and no more of great concern according to the present invention. Thus, using a weak acid and a salt thereof as buffer system, the limit value of the ionization constant of the acid can be higher than that of the previous example (10⁻⁴ moles/liter). In fact, in the limit case related to condition of formula [VIII],

$${K}_{a} = \frac{[ {H}^{+} ] [ {A}^{-} ]}{[ HA ]} \leq \frac{[ {H}^{+} ] 10 [ HA ]}{[ HA ]} = 10 [ {H}^{+} ]$$

that taking into account (VII) becomes

Kₐ≦10 [H⁺]=10·1·10⁻²=0.1 moles/liter (IX)

Therefore, it is an object of the present invention a water-activated primary battery using magnesium or alloys thereof as the anode and a cathode made of a material having a redox potential allowing a charge transfer reaction, said battery comprising one or more electrochemical cells in a casing, characterised by the fact of containing a pH buffer system made of at least one acid with a ionization constant Kₐ≦0.1 moles/liter, in order to maintain in the electrolytic solution the concentration of the hydroxyl ions (that are continuously produced by reaction (I) and, for cathodes based on a H₂O/H₂ system, also by the cathodic reactions (II) and (III)) below the threshold value which provokes under those conditions, the precipitation of Mg(OH)₂ and its deposition on the cathode with the consequent decrease of the output voltage between the battery terminals. Advantageously, the buffer system of the present invention further comprises a salt of said acid. The aforesaid threshold value of the OH⁻ ion concentration depends on the Mg²⁺ ion concentration and, to a lesser extent, on the temperature, since the value of the Mg(OH)₂ solubility product Kₚₛ, depends on such variable. Seawater temperature values usually range between −1° C. and 30° C. The reported value of the Mg(OH)₂ solubility product, at the intermediate temperature of 18° C., is 1.2·10⁻¹¹ mol³ l⁻³. Typically, a cell with a volume solution of 0.1 liter after having delivered a current of 0,25A for 4 hours, i.e., 1 Ah=3600 C, has introduced into the solution 3600/96500=3.7·10⁻² Mg²⁺ equivalents, i.e., 1.85·10⁻² moles. The corresponding Mg²⁺ concentration in the 0.1 liter solution is [Mg²⁺]=1.85·10⁻²/0.1=0.185 moles/liter. Therefore, from the expression of the solubility product it follows that under such conditions the minimum value of the OH⁻ concentration determining the Mg(OH)₂ precipitation is

$$[ {OH}^{-} ] = \sqrt{\frac{1 , 2 \cdot {10}^{- 11}}{0 \text{,} 185}} = 8 \cdot {10}^{- 6} moles / liter$$

corresponding to a pH value of

pH=14−pOH=14−6+0.9=8.9

In practice the cell pH must not exceed 9.

Among the substances with acidic functions and able to form a buffer system, possibly together with salts thereof, according to the present invention the following ones were found to be particularly suitable:

a) Carboxylic and polycarboxylic acids: acetic, propionic, glycolic, lactic, malic, tartaric, methatartaric, citric, D-gluconic, aspartic;

b) Acid salts of polycarboxylic acids: malic, tartaric, methatartaric, citric, aspartic, ethylenediaminetetraacetic (EDTA),

protonated forms of the substances including primary, secondary or tertiary aminic groups: triethanolamine, tri(hydroxy-methyl)aminomethane (TRIS), glycine, alanine, aspartic acid;

d) enols, e.g., ascorbic acid;

e) mono- and polyvalent phenols.

All these substances exhibit acidic behaviour. In fact, they are either <<classic>> weak acids (as e.g., acetic acid) that according to the Brönsted-Lowry theory transfer a proton to the medium

CH₃COOH+H₂O→CH₃COO⁻+H₃O⁺ (X)

(conjugate acid)₁ (conjugate base)₂ (conjugate base)₁ (conjugate acid)₂

or conjugate acids of a <<classic>> weak base, as e.g. an amine

R—NH₂+H₂O→R—NH₃⁺+OH⁻ (XI)

thus R—NH₃⁺, conjugate acid of R—NH₂, can in turn take part in proton transfers with reactions of the type

R—NH₃⁺+H₂O→R—NH₂+H₃O⁺ (XII)

i.e., with the reverse reaction of (XI).

In the electrolytic solution of a battery such as the one subject matter of present invention, an acid like CH₃COOH or triethanolammonium ion

⁺NH(CH₂CH₂OH)₃

(present, e.g., in triethanolamine solutions treated with HCl) exerts a buffer action on the pH as it reacts with the OH⁻ ions yielded from reaction (I) and possibly by reactions (II) and (IV). In fact,

CH₃COOH+OH⁻→CH₃COO⁻+H₂O (XIII)

⁺NH(CH₂CH₂OH)₃+OH⁻→N(CH₂CH₂OH)₃+H₂O (XIV)

In addition to the self-discharge caused by reaction (I), another drawback of the water-activated batteries is that of current losses, even at open circuit, between points of different cells connected by an usual electrolyte (seawater) and having a potential difference higher than the practical water discharge potential (about 1.5 V; theoretical potential 1.23 V). In the state of the art this drawback is overcome by means of small openings formed in the housings of the individual cells and using long conduits in order to obtain high resistance paths for said current losses. However, if the individual cells exhibit, at open circuit, an OCV (open circuit voltage) potential difference higher than the actual water discharge potential, then the self-discharge phenomena, i.e., the current losses inside an individual cell becomes evident even at open circuit.

To obtain greater volume and weight capacity and resistance to pressure change, the present invention, in addition to the use of a buffer inside the battery, also takes advantage of the spontaneous running and the products reaction (I) employing batteries enclosed in a casing that communicates with the outer environment by means of a single aperture.

Therefore, a further object of the present invention is a water-activated primary battery using magnesium or alloys thereof as anodes, contained in a casing, characterised in that at the top portion of said casing an aperture is formed for venting the hydrogen evolved (as a consequence of the battery activation) further to the reaction between the magnesium of the anode and the water (in cells using H₂O/H₂ as cathodic redox system, hydrogen results from the cathodic process as well), the arrangement being such that during underwater use even at great depths interdiffusion of the electrolytic solution of said battery with the water of the outside environment is prevented, and, at the same time, whereas a balancing of the internal and of the external pressures and the complete prevention of current losses between the individual cells of the battery are realised. Moreover, since the system is closed (as to a liquid exchange with the outside) with the exception of said aperture, high salt concentrations (e.g., 20-25% in salt) can be used, thus obtaining cells having small internal resistance, unlike what takes place in open type batteries where the electrolyte is seawater having a salt content usually ranging between 1.5% and 3.5%. Among salts, NaCl, KCl, CaCl₂, NH₄Cl, Na₂SO₄, K₂SO₄, and (NH₄)₂SO₄ were found to be particularly advantageous. It has to be pointed out that the battery according to the present invention can also operate with the same performances in fresh water (lakes, rivers, reservoirs) where normal water-activated open type batteries cannot operate.

If the position of the electrodes is fixed the consumption of the magnesium anode leads to an increase of the electrodic distance d, and therefore to an increase in the internal resistance of each individual cell of with the consequent CCV decrease. A further object of the present invention are various devices for keeping the electrodic distance constant.

In case of cylindrical anodes, constancy of distance d can be ensured with substantially cylindrical cathodic thin plates connected to return springs. In case of plate electrodes for the aforesaid purpose, springs pressing the cathode-spacers-anode system can be used.

### BRIEF DESCRIPTION OF THE DRAWINGS

Eight tables with drawings are annexed to the present description, showing:

FIG. 1, the titration curve (continuous line) of 1 liter of 0.1 M acetic acid solution with NaOH, i.e., the diagram depicting the solution pH as a function of the additioned NaOH moles; the dotted line depicts the pH trend in the case of NaOH addition to pure water;

FIG. 2, a schematic sectional view of a battery according to the present invention;

FIG. 3, an enlarged sectional view of a detail in FIG. 2;

FIG. 4, a section of FIG. 2 taken along the section plane AB in FIG. 2;

FIG. 5 in detail a), a section of a possible version of the cathode-spacers-anode array of the battery shown in FIG. 2; in detail b), an axonometry of said version of the cathode-spacers-anode array;

FIGS. 6, 7 and 8 show discharge curves (CCV versus time) of three different battery types according to the present invention, each consisting of an individual cell.

The present invention will be hereinafter described in detail with reference to a presently preferred embodiment thereof.

In FIG. 2 a battery according to the present invention enclosed in a casing 1 is shown. The anode 2 is made of a substantially cylindrical body, of magnesium or of an alloy thereof, whereas the cathode 3 is annularly positioned around said anode. Spacers 4 of insulating material prevent the electrical contact between the anode and the cathode. Rheophores 5 are connected to the cathode and to the anode, the ends thereof coming out from the battery. A rheophore is tightened onto the anode with a bolt 6, whereas the other rheophore can be welded onto the cathode or tightened thereon with bolt and nut. The points of contact of the rheophores with the electrodes are coated with a insulating resin 7. The anode-cathode array rests onto supports 8 restraining the movements of the electrodes and, in the particular arrangement shown in FIG. 2, create a space 9 that eases the electrolyte circulation in the interelectrodic space.

With reference to FIG. 3, the upper portion of the casing 1 is described. The casing 1 has a collar portion 10 ending in a annular plane portion 11. The collar portion 10 has a outer threading 12 that can be fitted to a ring nut member 13, the latter also provided with a corresponding threading 14 and having a central opening 15. Moreover, according to the invention a flanged plug member 16 that can be tightened between the portion 11 and the member 13 is provided. An aperture 17 for venting the hydrogen yielded by reaction (1) is formed in the member 16. Further, the member 16 is provided with a pair of through members 18, in turn crossed by the battery rheophores. Between the flanged plug member 16 and the plane portion 11 of the collar member, a gasket 19, preferably a o-ring, is provided in order to improve the seal. A couple of through members 18 is further provided with a outer threading 20 that can be coupled with a corresponding threaded seat 21 formed in the member 16 and located above a conical seat 22. A second gasket 24, preferably an o-ring, and a washer 23 are provided between the conical seat 22 and the ledge of the through members 18.

When the member 13 is tightened onto the collar member 10 by mutual engagement of the threading 12 and 14, the member 13 forces the flanged plug member 16 onto the collar member 10. Thus, through the effect of the gasket 19 a seal of the casing is realized and ensured. The gaskets exert an analogous sealing and securing action on the rheophores.

Consequently the inside of the battery communicates with the outer environment exclusively through the aperture 17, through which, however, the hydrogen yielded by reaction (I) and possibly by reactions (II) and (III), is vented.

In FIG. 4 the cross-sectional view of FIG. 2 taken along the plane AB is reported. Therein, the casing 1, the anode 2, and the cathode 3, shaped as a cylinder cleft along the generating line and with the two edges thereof folded to form two wings 25 each having two holes, are shown. Onto opposed holes of the two wings two springs 26 are hooked, extended with respect to their rest position. Thus, constancy of the electrodic distance is ensured regardless of the anode consumption, since the spacers located onto the cathode (cemented onto the cathode or fit into holes formed in the cathode) are always contacting the anode. Thus, a widening of the electrodic distance and therefore the increase in the internal resistance, which would provoke a decrease of the delivered current, is prevented. The supports 8 support the cathode-spacers-anode array.

In FIGS. 5a and b a variant of cathode-spacers-anode array, with a substantially plane plate as the anode is reported. The array rests onto the supports 8. The system is maintained in its position by the insulating elements 8 and 8a. The cathodic material is an elastic metal plate (steel, not annealed brass, phosphorous bronze) generally covered with a more active metallic film. The cathode 3 has the shape of a plate facing the anode 2 and separated from the latter by the insulating elements 4. The cathodic plate presents at one side a ribbon 26a (of the same cathodic material) which is bent to push the back of the anode where, in the middle of it, there is a longitudinal notch 27. The back of the anode, including the, notch, is covered with insulating paint 28. The ribbon 26a plays the role of a spring (as used in FIG. 4 and shown in as 26) pushing the anode towards the cathode realizing the constancy of the interelectrodic distance despite the consumption of the anodic surface during the discharge.

In this case the CCV exhibits a slow decline during the discharge, and when its value has undergone a 13% decrease, and therefore the power output exhibits a 25% decrease, the battery can be considered as run-down.

A further object of the present invention is a method for regenerating the battery one or more times by adding electrolytes to the buffer solution in the run-down battery. Said added electrolytes reduce the internal resistance of the battery thereby increasing the CCV. Adding substances of acidic nature is particularly advantageous in case of batteries with H⁺/H₂ cathodes, since, besides reducing the internal resistance, they increase the cathode potential, thus remarkably increasing the CCV.

The cells, whose discharge curves are reported in FIGS. 6, 7 and 8 were housed inside plastic casings with a volume of 125 ml. Such value was used in the calculation of the volumetric capacity, whereas in the calculation of the gravimetric capacity the weight of the casing was not taken into account, as it can range in a wide interval. Instead, the weights of the electrodes, of the electrolytes and of the inner wires were taken into account. Moreover, the water weight was not taken into account, as it can be added at the time of activation.

In FIG. 6, the discharge curve of the cell

$$Mg \vert \begin{matrix}\begin{matrix}\begin{matrix}lactic acid , sodium lactate , \\ glicolic acid , sodium glicolate , \end{matrix} \\ sea water , ( pH = 3.6 ) \end{matrix} \\ {NaHSO}_{4} \cdot {H}_{2} O as an additional electrolyte\end{matrix} \vert {H}_{2 ,} Fe \text{-} Ni alloy / Cu$$

connected at 18° C. on a 2.9 ohm resistance and subject to two regeneration processes by means of NaHSO₄.H₂O added to the solution is reported. pH values of the solution are indicated by the round bracketed integers in FIG. 6. It can be seen that discharge takes place in 2 hrs 30 min; accordingly the solution pH rises from 3.6 to 4.0. Then, adding solid NaHSO₄.H₂O and shaking, the substance dissolves and the pH drops to 3.3. Then the cell can operate 1 h 50 min and the pH rises up to 3.75. Adding more NaHSO₄.H₂O and shaking, the pH drops again to 3,3. The cell can operate for another 1 h 15 min. Without adding NaHSO₄.H₂O, the volumetric capacity of the cell would have been of 3.1 Wh/L and the gravimetric capacity of 4,6 Wh/kg (not accounting for the seawater). At the end of the two subsequent discharge periods, the resulting volumetric capacity is of 6.5 Wh/L whereas the gravimetric one is of 9.3 Wh/kg.

The discharge curve in FIG. 7 refers to the following cell, made of non-toxic materials.

$$Mg \vert \begin{matrix}\begin{matrix}\begin{matrix}citric acid , tripotassium citrate , \\ ascorbic acid , sodium chloride , \end{matrix} \\ ( pH = 4.2 ) \end{matrix} \\ {NaHSO}_{4} \cdot {H}_{2} O as an additional electrolyte \end{matrix} \vert {H}_{2 ,} Pd / steel$$

The volumetric and the gravimetric capacities of such environmentally safe cell, connected at 25° C. on a 5.1 ohm resistance are 7.6 Wh/L and 11.2 Wh/kg respectively. With NaHSO₄.H₂O as additional electrolyte a regeneration can be carried out, and the overall volumetric and the gravimetric capacities are of 10.8 Wh/L and 16.1 Wh/kg.

The discharge curve as showed in FIG. 8 is relative to another ecological cell

$$Mg \vert \begin{matrix}\begin{matrix}citric acid , tripotassium citrate , \\ potassium chloride , ( pH = 4.3 ) \end{matrix} \\ {NaHSO}_{4} \cdot {H}_{2} O as an additional electrolyte \end{matrix} \vert {H}_{2 ,} Pt / Pd / brass$$

At 22° C. this cell was discharged through a 4.7 ohm load. Its volumetric and gravimetric capacities were 10.0 Wh/kg and 16.4 Wh/kg respectively. By using NaHSO₄•H_{2O} as an additional electrolyte, the exhausted cell could be regenerated and its capacities rose to 14.3 Wh/L and 19.4 Wh/kg respectively.

In an environmentally safe cell according to the present invention, the anode is made of pure magnesium, whereas the cathode is based on the H⁺/H₂ redox system, supported on non-polluting metals or conductive materials like stainless steel, noble metal films, like platinum, palladium-films and platinum-palladium alloy-film on stainless steel, brass, naval brass (brass 60), silver, graphite, conductive carbon; the electrolytic solution can contain relatively non-toxic substances, for which e.g., the lethal dose for the 50% of rats for a group of rats to which said substance has been administered orally, i.e. LD₅₀ oral rat, is higher than or equal to 3 g of substance/kg bw. Therefore, the electrolytic solution can include NaCl, KCl, CaCl₂, Na₂SO₄, K₂SO₄, lactic acid, sodium lactates, potassium and calcium lactates, malic acid, sodium and potassium malates, citric acid, sodium and potassium citrates, tartaric acid, sodium tartrates, ascorbic acid, sodium and potassium ascorbates, tri(hydroxymethyl)aminomethane (TRIS) and its protonated form.

To regenerate an environmentally safe cell according to the present invention, ascorbic acid, tartaric acid, sodium hydrogen tartrate, malic acid, sodium hydrogen malate, potassium hydrogen malate, citric acid, sodium dihydro citrate, disodium hydrocitrate, potassium dihydrocitrate, dipotassium hydrocitrate, NaHSO₄.H₂O, KHSO₄, NaCl, KCl, CaCl₂, Na₂SO₄, K₂SO₄, HCl, H₂SO₄, protonated forms of tri(hydroxy-methyl)aminomethane, of glycine, of alanine, of aspartic acid, and possible mixtures of the aforesaid electrolytes can be used.

Although the present invention has hereto been described with reference to a presently preferred embodiment thereof, it is understood that in practice variants and modifications may be effected therein by a person skilled in the art, all however without departing from scope of protection of the present industrial title.

1. A Water-activated primary battery using magnesium or alloys thereof as the anode, and a cathode of a material having a redox potential allowing a charge transfer reaction, said battery including one or more electrochemical cells enclosed in a casing (1), characterised in that it contains a pH buffer system made of at least one acid having a ionization constant Kₐ≦0.1 moles/liter in order to maintain in the electrolytic solution the concentration of the hydroxyl ions yielded by the reaction
Mg+2 H₂O→Mg²⁺+2OH⁻+H₂↑ (I)
below the threshold value causing the Mg(OH)₂ precipitation, said precipitation being also provoked by the increase of the Mg₂ concentration due to the anodic reaction
Mg→Mg²⁺+2 e, (V)
thereby avoiding the deposition of Mg (OH)₂ on the cathode with the consequent decrease of the voltage output from said battery.

2. The battery according to claim 1, wherein said buffer system further comprises a salt of said acid.

3. The battery according to claims 1 or 2, characterised in that at the upper part of said casing an aperture (17) is formed, through which the hydrogen evolved due to the battery activation is vented, said battery communicating with the outside environment exclusively by means of said aperture, the arrangment being such that during underwater use, even at great depths, the seeping of the water of the outside environment inside the cells of said battery is prevented, and the balancing between the internal and the external pressure and a complete prevention of current losses between the individual cells of the battery are realized.

4. The battery according to any one of the preceding claims, wherein said at least one acid is selected from the group comprising: mono- or poly- carboxylic acids and salts thereof, amino acids and protonated forms thereof, monovalent and polyvalent phenols, salts of polyvalent phenols, enols.

5. The battery according to claim 4, wherein said mono- or poly- carboxylic acids are selected from the group comprising: citric, acetic, glycolic, lactic, malic, D-gluconic, tartaric, methatartaric, ascorbic acid.

6. The battery according to claim 4, characterised in that said salts of mono- or poly- carboxylic acids belong to the group comprising the salts of the following acids: citric, malic, tartaric, methatartaric, ethylendiaminotetracetic (EDTA).

7. The battery according to claim 4, characterised in that said amino acids are selected from the group comprising: glycine, α-alanine, aspartic acid.

8. The battery according to claim 4, wherein an enol is ascorbic acid.

9. The battery according to any one of the preceding claims, comprising
an anode (2) of substantially cylindrical shape;
a cathode (3) annularly located around said anode;
one or more spacers (4), made of insulating material, inserted between said cathode and said anode; and
means (5) for the electrical connection among the various battery components.

10. The battery according to claim 9, characterised in that it further comprises a plurality of supports (8) for said anode and said cathode.

11. The battery according to claim 10, wherein said plurality of supports is shaped so as to form a space (9) below said cathode and anode in order to ease the electrolyte circulation in the electrode gap.

12. The battery according to any one of the preceding claims, wherein said casing includes in a reversible mechanical arrangement
a collar portion (10) provided with an outer threading (12) that can be screwed to a ring nut member (13) correspondingly provided with a threading (14), said opening centrally having said aperture (17);
a flanged plug member (16) that can be tightened between said collar portion and said ring nut member;
said plug member being provided with a pair of through members (18) crossed by the terminals (5) of said battery, and having said aperture to allow in a controlled manner the contact of the internal environment of said casing with the surrounding outer environment.

13. The battery according to claim 12, wherein an O-ring is provided between said flanged plug member and said collar portion.

14. The battery according to claims 12 or 13, characterised in that said pair of through members is provided with a outer threading (20) that can be coupled to a corresponding threaded seat (21) formed in said flanged plug member.

15. The battery according to any one of the claims 1 to 14, wherein said aperture is sized so as to allow the venting of the gas evolved by the battery activating reactions between the inside of said casing and the surrounding environment, and to prevent seeping in of fluid from the outer environment.

16. A process for the battery regeneration as claimed in claims 1 to 15, comprising adding of electrolytes to the buffer solution of the exhausted batteries.

17. The process according to claim 16, wherein in case of batteries using cathodes based on the H⁺/H₂ system said electrolytes are substances of acidic nature.
